(19) United States
(12) Patent Application Publication
(10) Pub. No.: US 2017/0225792 A1
(43) Pub. Date: Aug. 10, 2017

(54) PARACHUTE DEPLOYMENT SYSTEM FOR AN UNMANNED AERIAL VEHICLE

(71) Applicant: DroneTech Studio, LLC, Highlands Ranch, CO (US)

(72) Inventors: Liang Wang, Highlands Ranch, CO (US); Daniel Joseph Bodenstein, Boulder, CO (US); Ryan Michael Welsh, Boulder, CO (US); Kevin Ian McWilliams, Boulder, CO (US)

(21) Appl. No.: 15/503,089

(22) PCT Filed: Aug. 11, 2015
(86) PCT No.: PCT/US15/44597

§ 371 Date: Feb. 10, 2017

Related U.S. Application Data
(60) Provisional application No. 62/168,462, filed on May 29, 2015.
(60) Provisional application No. 62/036,692, filed on Aug. 13, 2014.

(51) Int. Cl. B64D 17/70; B64D 17/80; B64C 39/02

(52) U.S. Cl. CPC B64D 17/70; B64C 39/024; B64D 17/80; B64C 2201/185

(57) ABSTRACT

Various embodiments of the present disclosure relate to a parachute deployment system for an unmanned aerial vehicle (UAV). In some examples, the parachute deployment system includes a base attached to the unmanned aerial vehicle, a deployment tray mechanically connected to the base, an acceleration mechanism for propelling the deployment tray away from the base, a parachute cover releasably secured over the deployment tray, a parachute stowed between the deployment tray and the parachute cover, and a triggering mechanism. Upon activation of the triggering mechanism, the parachute cover is released and the deployment tray is propelled away from the base, which rapidly deploys the parachute away from the UAV.

### CROSS-REFERENCE TO RELATED APPLICATIONS

This application claims priority to U.S. provisional application number 62/036,692, filed on Aug. 13, 2014, and U.S. provisional application number 62/168,462, filed on May 29, 2015, which are incorporated by reference herein in their entirety.

### TECHNICAL FIELD

The present technology relates generally to a rapid-deployment parachute system for an unmanned aerial vehicle.

### BACKGROUND

Small, remote-controlled aircraft (such as multi-rotor or fixed wing aerial vehicles) are becoming increasingly popular for various applications, frequently including, but not limited to, aerial filming, delivery service, and surveys. However, obstacles within the flight environment, vehicle malfunction, battery failure, and/or minimally trained pilots may cause the aircraft to crash, resulting in damage to the aircraft. A falling aircraft may also present safety hazards to the public. Such accidents often occur at low flight altitudes and speeds. Existing techniques for recovering a falling aircraft at low altitudes include, for example, launching a parachute from the aircraft using pyrotechnic charges or compressed gas. These techniques may negatively impact the flight time and flight characteristics of the aircraft, due to their size, shape, and weight. Use of compressed gas and pyrotechnic materials may also limit areas where the aircraft and/or parachute may be taken, such as onboard commercial aircraft when traveling.

### SUMMARY

The present disclosure relates to a parachute deployment system for an unmanned aerial vehicle. In a particular embodiment, the parachute deployment system includes a base attached to the unmanned aerial vehicle; a deployment tray mechanically connected to the base; an acceleration mechanism for propelling the deployment tray away from the base; a parachute cover releasably secured over the deployment tray; a parachute stowed between the deployment tray and the parachute cover, the parachute having a plurality of suspension lines for supporting the unmanned aerial vehicle when the parachute is deployed; and a triggering mechanism. Upon activation of the triggering mechanism, the parachute cover is released and the deployment tray is propelled away from the base, deploying the parachute.

In some examples, releasing the parachute cover causes the acceleration mechanism to propel the deployment tray away from the base. In some examples, the parachute cover is releasably secured over the deployment tray by a plurality of doors. In some examples, the parachute includes one or more torsion springs for rapidly inflating the parachute, and the plurality of doors at least partially hold the one or more torsion springs in a compressed state while the parachute is stowed. In some examples, the triggering mechanism causes the plurality of doors to release the parachute cover at approximately the same time that the deployment tray is propelled away from the base.

In some examples, the parachute cover comprises a plurality of hinged sections, each hinged section spreading away from each other hinged section upon release of the parachute cover. In some examples, each hinged section includes a spring mechanism for accelerating the spreading away from each other hinged section. In some examples, the released parachute cover acts as a pilot chute, which pulls the parachute away from the unmanned aerial vehicle and allows the parachute to inflate.

In some examples, the acceleration mechanism raises the deployment tray away from the base to a distance that allows the parachute and parachute suspension lines to clear one or more rotors of the unmanned aerial vehicle. In some examples, the parachute suspension lines are at least partially stored within the deployment tray. In some examples, the parachute suspension lines are at least partially stored within pockets of the parachute.

In some examples, the parachute cover approximately conforms to a central body shape of the unmanned aerial vehicle. In some examples, the base is integral to the unmanned aerial vehicle. In some examples, the parachute deployment system is at least partially contained within the unmanned aerial vehicle. In some examples, the parachute cover forms a central portion of the body of the unmanned aerial vehicle. In some examples, the triggering mechanism is activated based on an automatic triggering system, a user command, or a combination thereof. In some examples, the parachute includes one or more air vents controlled by the parachute deployment system when the parachute is released.

The present disclosure further relates to an unmanned aerial vehicle. In a particular embodiment, the unmanned aerial vehicle includes a body; at least one rotor; and a parachute deployment system, the parachute deployment system. The parachute deployment system includes a base attached to the body; a deployment tray mechanically connected to the base; an acceleration mechanism for propelling the deployment tray away from the base; a parachute cover releasably secured over the deployment tray; a parachute stowed between the deployment tray and the parachute cover, the parachute having a plurality of suspension lines for supporting the unmanned aerial vehicle when the parachute is deployed; and a triggering mechanism. Upon activation of the triggering mechanism, the parachute cover is released and the deployment tray is propelled away from the base, deploying the parachute.

The present disclosure further relates to a method for deploying a parachute on an unmanned aerial vehicle. In a particular embodiment, the method includes activating a triggering mechanism; propelling a deployment tray away from the unmanned aerial vehicle; releasing a parachute cover approximately simultaneously to the propelling of the deployment tray; and deploying a parachute stowed between the deployment tray and parachute cover. The method allows the parachute to be propelled away from the unmanned aerial vehicle by the deployment tray.

It is to be understood that both the foregoing summary and the following detailed description are for purposes of example and explanation and do not necessarily limit the present disclosure. The accompanying drawings, which are incorporated in and constitute a part of the specification, illustrate subject matter of the disclosure. Together, the descriptions and the drawings serve to explain the principles of the disclosure.

### BRIEF DESCRIPTION OF THE DRAWINGS

Many aspects of the present disclosure can be better understood with reference to the following drawings. The components in the drawings are not necessarily to scale. Instead, emphasis is placed on illustrating clearly the principles of the present disclosure.

FIG. 1A illustrates an embodiment of a UAV, in accordance with various aspects of the present disclosure.

FIG. 1B illustrates another embodiment of a UAV, in accordance with various aspects of the present disclosure.

FIG. 2A illustrates a perspective view of an embodiment of a parachute deployment system in a partially deployed state, in accordance with various aspects of the present disclosure.

FIG. 2B illustrates a side view of an embodiment of the parachute deployment system in a partially deployed state, in accordance with various aspects of the present disclosure.

FIG. 3A illustrates a perspective view of an embodiment of the parachute deployment system in a stowed state, in accordance with various aspects of the present disclosure.

FIG. 3B illustrates another perspective view of an embodiment of the parachute deployment system in a stowed state, in accordance with various aspects of the present disclosure.

FIG. 4 illustrates an alternative embodiment of a base and acceleration mechanism, in accordance with various aspects of the present disclosure.

FIG. 5A illustrates a perspective view of an embodiment of a parachute deployment system in a partially deployed state, in accordance with various aspects of the present disclosure.

FIG. 5B illustrates a perspective view of an embodiment of the parachute deployment system, in accordance with various aspects of the present disclosure.

FIG. 6A illustrates a perspective view of an embodiment of the parachute deployment system in a stowed state, in accordance with various aspects of the present disclosure.

FIG. 6B illustrates another perspective view of an embodiment of the parachute deployment system in a stowed state, in accordance with various aspects of the present disclosure.

FIG. 7A illustrates a perspective view of an embodiment of a parachute, in accordance with various aspects of the present disclosure.

FIG. 7B illustrates a perspective view of an embodiment of the parachute deployment system, in accordance with various aspects of the present disclosure.

FIG. 7C illustrates a sectional view of an embodiment of the parachute deployment system, in accordance with various aspects of the present disclosure.

FIG. 8A illustrates a perspective view of an embodiment of a parachute, in accordance with various aspects of the present disclosure.

FIG. 8B illustrates an embodiment of a deployment tray top and launching mechanism for a parachute deployment system, in accordance with various aspects of the present disclosure.

FIG. 9 illustrates an embodiment of a steerable parachute, in accordance with various aspects of the present disclosure.

### DETAILED DESCRIPTION

The present technology is directed to a parachute deployment system for an unmanned aerial vehicle (UAV). The parachute deployment system deploys a parachute within a small amount of time by using mechanical systems to propel the parachute away from the UAV and accelerate the opening of the parachute. The parachute deployment system is also light, compact, and aerodynamic to minimize the impacts to flight time and flying characteristic of the UAV, as further described herein.

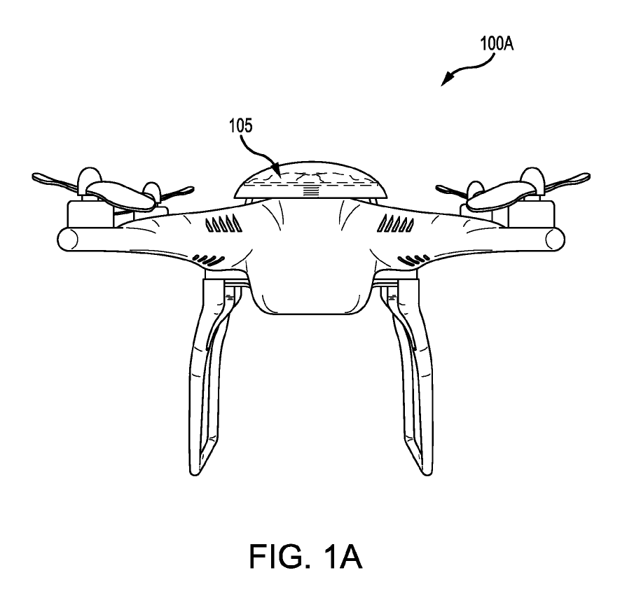

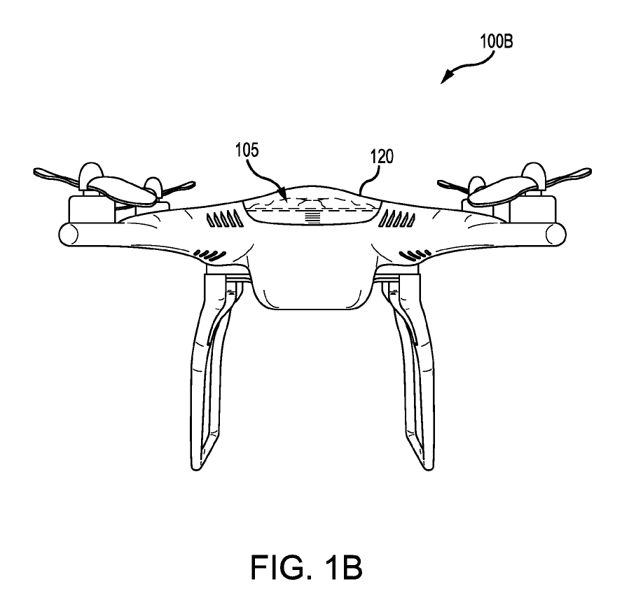

Specific details of several examples of the present technology are described below with reference to FIGS. 1A-8B. Additionally, several other embodiments of the technology can have different configurations, components, or procedures than those described herein. A person of ordinary skill in the art, therefore, will accordingly understand that the technology can have other embodiments with additional elements and that the technology can have other embodiments without several of the features shown and described below with reference to FIGS. 1A-8B.

### Terminology

Brief definitions of terms and phrases used throughout this application are given below.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

If the specification states a component or feature “may”, “can”, “could”, or “might” be included or have a characteristic, that particular component or feature is not required to be included or have the characteristic.

Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded.

### General Description

FIG. 1A illustrates an embodiment of an unmanned aerial vehicle (UAV) 100A, in accordance with various aspects of the present disclosure. The UAV 100A includes a parachute deployment system 105 attached to the body of the UAV 100A. The parachute deployment system 105 may attach to the UAV 100A using a variety of attachment devices, such as elastic cords, glue, screws, bolts, or other means. Alternatively, a base of the parachute deployment system 105 may be formed integral to the body of the UAV 100A. The parachute deployment system 105 may include a cover that approximately conforms to the shape of a central portion of the UAV body. The shape the parachute deployment system 105 substantially maintains the aerodynamic characteristics of the UAV 100A. In addition, the parachute deployment system 105 is compact and has a low-profile in order to have a minimal impact on the center-of-gravity of the UAV 100A. The shape, weight, and placement of the parachute deployment system 105 allows the flight time and flight characteristics of the UAV 100A to be minimally impacted by the addition of the parachute deployment system 105.

When a parachute is deployed from the parachute deployment system 105, the parachute inflates and allows the unmanned aerial vehicle 100A to descend at a reduced speed in an emergency. The parachute deployment system 105 propels the parachute away from the UAV 100A such that the parachute is not entangled with any components of the UAV 100A or the parachute deployment system 105. Furthermore, the parachute deployment system 105 may accelerate the opening of the parachute so that the parachute inflates quickly. This may allow the parachute to be effective when deployed at low altitudes.

FIG. 1B illustrates another embodiment of a UAV 100B, in accordance with various aspects of the present disclosure. The UAV 100B includes a parachute deployment system 105 contained within the body of the UAV 100B. Components of the parachute deployment system 105 may be formed integral to the UAV 1008. For example, a base of the parachute deployment system 105 may be integral to the body of the UAV 1008. A parachute cover 120 of the parachute deployment system 105 may form a central portion of the body of the UAV 1008 while a parachute is stowed in the parachute deployment system 105. The parachute cover 120 may be shaped to substantially maintain the aerodynamic characteristics of the UAV 100A. In addition, the parachute deployment system 105 is compact and light weight in order to have a minimal impact on the center-of-gravity of the UAV 1008. The shape, weight, and placement of the parachute deployment system 105 allows the flight time and flight characteristics of the UAV 1008 to be minimally impacted by the addition of the parachute deployment system 105.

When a parachute is deployed from the parachute deployment system 105, the parachute inflates and allows the unmanned aerial vehicle 1008 to descend at a reduced speed in an emergency, similar to the UAV 100A described in reference to FIG. 1A.

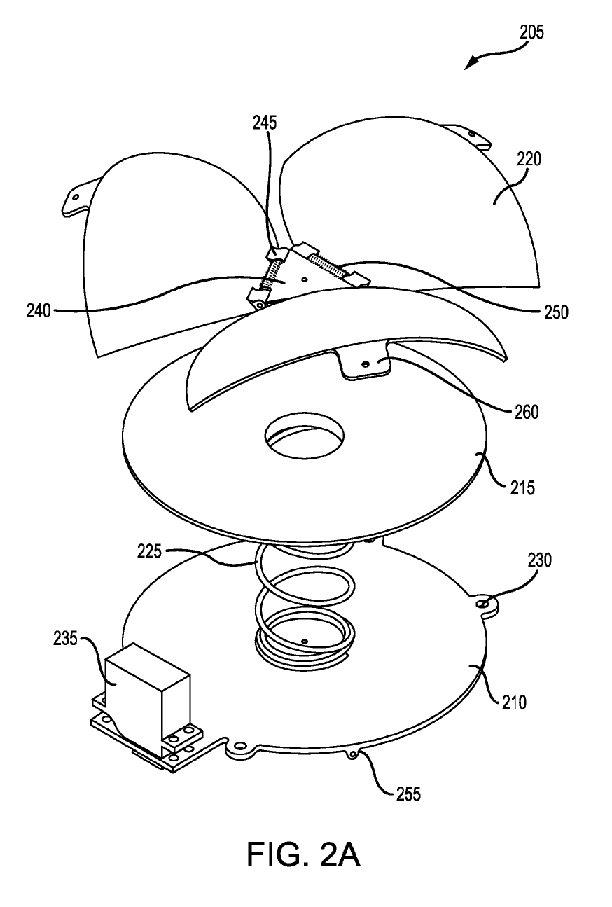

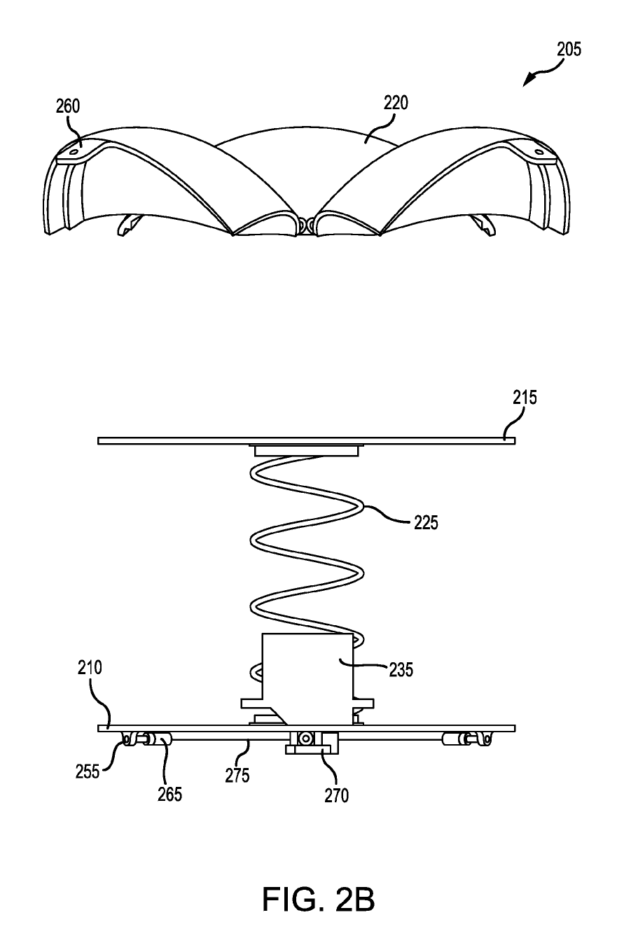

FIG. 2A illustrates a perspective view of an embodiment of a parachute deployment system 205 in a partially deployed state, in accordance with various aspects of the present disclosure. The parachute deployment system 205 includes a base 210, a deployment tray 215, and a parachute cover 220. An acceleration mechanism 225 mechanically connects the deployment tray 215 to the base 210. While shown as a coil spring, the acceleration mechanism 225 may include other types of devices that store mechanical energy, such as leaf springs or elastic bands. A parachute (not shown) is positioned between the parachute cover 220 and the deployment tray 215. The parachute may include multiple suspension lines that attach to the base 210 or that attach directly to a UAV. When the parachute is deployed, the suspension lines support the UAV and allow the UAV to descend at a reduced speed.

The base 210 may attach to the UAV via attachment points 230. For example, screws may attach the base 210 to the body of the UAV via the attached points 230. Alternatively, in some embodiments, the base 210 may not include attachment points 230, and instead may be integral to the UAV, such as shown in FIG. 1B. In these embodiments, the parachute cover 220 may form a portion of the body of the UAV.

A triggering mechanism 235 may release the parachute cover 220 and cause the acceleration mechanism 225 to propel the deployment tray 215 away from the base 210, as shown in FIG. 2A. The triggering mechanism 235 may include a power source (e.g., a battery) and control electronics. The triggering mechanism 235 may be triggered manually, by the pilot of the UAV via remote-control, or automatically by an automatic triggering system. The automatic triggering system may be a component of the UAV or may be a component of the parachute deployment system 205 (e.g., a component of the triggering mechanism 235). The automatic triggering system may use sensor data either from the UAV's onboard flight control system or from sensors built into the control electronics of the triggering mechanism 235. The triggering mechanism 235 may be automatically activated when any of a set of rules is broken. For example, the rules may include excessive rotation rate in any control axis, excessive tilt angle from horizontal in any control axis, detection of excessively fast downward motion, loss of power onboard the UAV to any or all propulsion systems, and/or loss of control of the UAV due to signal interference or malicious intervention (e.g., hacking of the UAV control signals).

In some embodiments, the parachute deployment system 205 and/or UAV may include a recording device to record and report data, such as flight path, location, and crash conditions. The recording device may include sensors to record the status of various components of the UAV, such as rotor speed and battery level. The recording device may transmit the recorded data to a receiving device upon a crash condition or upon a user command. Alternatively, the recorded data may be retrieved from the recording device manually by a user, such as with a USB interface.

When the parachute cover 220 is released by the triggering mechanism 235, the parachute cover 220 may spread into multiple sections. The sections of the parachute cover 220 are connected via hinges 245 to a central cover portion 240. Springs 250 in the hinges 245 cause the sections of the parachute cover 220 to actively and rapidly spread away from one another after the parachute cover 220 is released. While shown with three sections in FIG. 2A, the parachute cover 220 may spread into different numbers of sections (such as two or four) using similar mechanisms. Furthermore, while the parachute cover 220 is shown as a hinged dome in FIGS. 1A and 2A, the parachute cover 220 may be shaped in other ways. For example, parachute cover 220 may be shaped as a cone, a pyramid, or other shapes.

A pilot line (not shown) may connect the central cover portion 240 of the parachute cover 220 to the parachute. Thus, when the parachute cover 220 is released and spreads apart, the parachute cover 220 may act as a pilot chute for the parachute, pulling the parachute, via the pilot line, away from the parachute deployment system 205 and the UAV. By pulling on the parachute with the parachute cover 220, the parachute may rapidly inflate away from the UAV. In addition, the pilot line may keep the parachute cover 220 connected to the parachute deployment system 205 and UAV, allowing the parachute cover 220 to be reused. In some embodiments, the parachute cover 220 may include a flexible or elastic material (not shown) between the sections of the parachute cover 220. The flexible material may provide the parachute cover 220 with more drag and may allow the parachute cover 220 to more efficiently pull on the parachute when it is released.

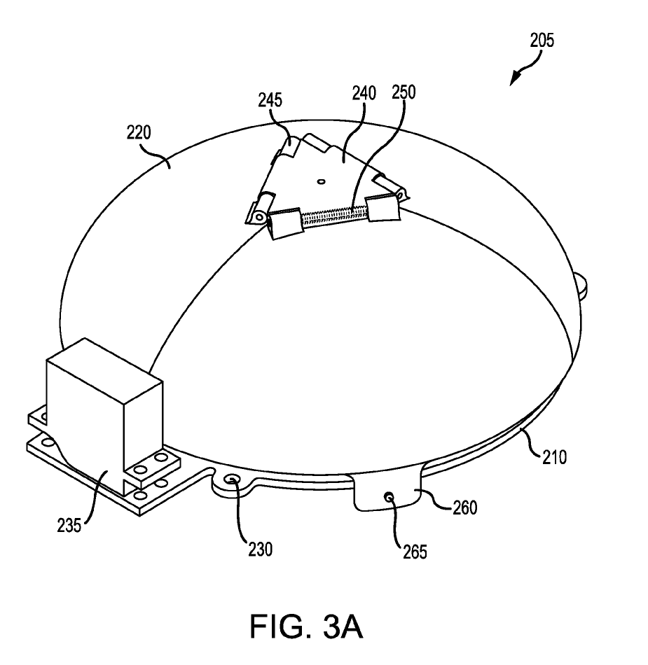

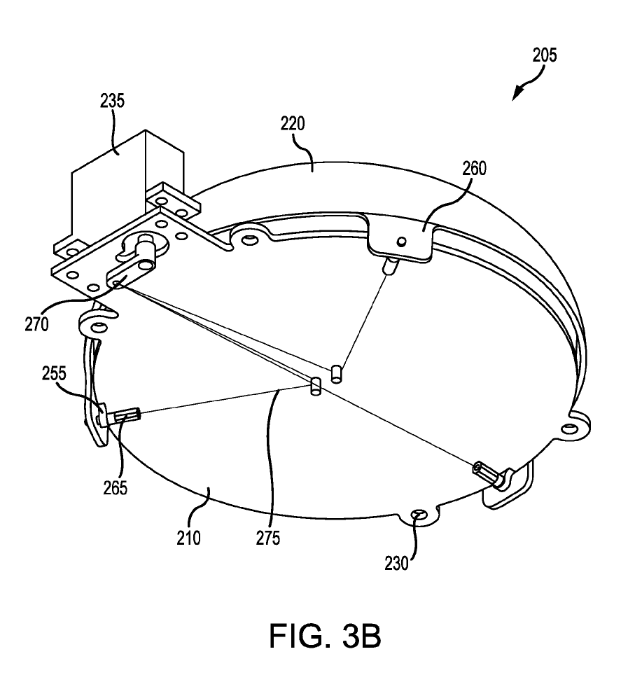

The parachute cover 220 may be released when release pins (as shown in FIGS. 2B and 3B) are retracted by the triggering mechanism 235. The release pins extend through securement holes 255 in the base 210 and into securement tabs 260 in each section of the parachute cover 220. In some embodiments, when the parachute cover 220 is secured to the base 210, the parachute cover 220 also compresses the acceleration mechanism 225 and holds the deployment tray 215 in a position near the base 210. Alternatively, in other embodiments, the acceleration mechanism 225 may be compressed and the deployment tray 215 may be secured in a position near the base 210 by a separate latching mechanism (not shown). In these embodiments, the deployment tray 215 and parachute cover 220 may be released by the triggering mechanism 235 at approximately the same time. For example, the triggering mechanism 235 may retract the release pins securing the parachute cover 220 at approximately the same time that the latch securing the deployment tray 215 is released.

FIG. 2B illustrates a side view of an embodiment of the parachute deployment system 205 in a partially deployed state, in accordance with various aspects of the present disclosure. As described in reference to FIG. 2A, the parachute deployment system 205 includes a base 210, a deployment tray 215, a parachute cover 220, and an acceleration mechanism 225. A parachute (not shown) is positioned between the deployment tray 215 and parachute cover 220. A pilot line may connect the parachute and the parachute cover 220, allowing the parachute cover 220 to act as a pilot chute when released, and keeping the parachute cover 220 connected to the parachute deployment system 205 and UAV. In some embodiments, the parachute cover 220 may include a flexible or elastic material (not shown) between the sections of the parachute cover 220. The flexible material may provide the parachute cover 220 with more drag and may allow the parachute cover 220 to more efficiently pull on the parachute when it is released.

The parachute cover 220 is released when release pins 265 are retracted by the triggering mechanism 235. The release pins 265 extend through securement holes 255 in the base 210 and into securement tabs 260 in each section of the parachute cover 220. The triggering mechanism 235 may retract the release pins 265 by rotating a release lever 270 with a servo-actuator. The release pins 265 may be connected to the release lever 270 by linkages 275. When the triggering mechanism 235 actuates the release lever 270, the linkages 275 are pulled simultaneously, which causes each of the release pins 265 to retract from the securement tabs 260 at approximately the same time. The sections of the parachute cover 220 may then spread apart and the acceleration mechanism 225 may propel the deployment tray 215 (and thus the parachute) away from the base 210. The combination of the deployment tray 215 propelling the parachute away from the base 210 and the parachute cover 220 pulling on the parachute (similarly to a pilot chute) causes the parachute to rapidly inflate away from the UAV. This may prevent the parachute and/or parachute suspension lines from being entangled with components of the UAV (such as rotors).

FIG. 3A illustrates a perspective view of an embodiment of the parachute deployment system 205 in a stowed state, in accordance with various aspects of the present disclosure. As described in reference to FIGS. 2A and 2B, the parachute deployment system 205 includes a base 210, a deployment tray (as shown in FIGS. 2A and 2B) and a parachute cover 220. A parachute (not shown) is stowed in the volume between the deployment tray and the parachute cover 220.

The base 210 may attach to the UAV via attachment points 230. For example, screws may attach the base 210 to the body of the UAV via the attached points 230. Alternatively, in some embodiments, the base 210 may not include attachment points 230, and instead may be integral to the UAV, such as shown in FIG. 1B. In these embodiments, the parachute cover 220 may form a portion of the body of the UAV.

A triggering mechanism 235 may release the parachute cover 220 and cause an acceleration mechanism (as shown in FIGS. 2A and 2B) to propel the deployment tray away from the base 210. The triggering mechanism 235 may include a power source (e.g., a battery) and control electronics. The triggering mechanism 235 may be triggered manually, by the pilot of the UAV via remote-control, or automatically by an automatic triggering system. The automatic triggering system may be a component of the UAV or may be a component of the parachute deployment system 205 (e.g., a component of the triggering mechanism 235). The automatic triggering system may use sensor data either from the UAV's onboard flight control system or from sensors built into the control electronics of the triggering mechanism 235. The triggering mechanism 235 may be automatically activated when any of a set of rules is broken. For example, the rules may include excessive rotation rate in any control axis, excessive tilt angle from horizontal in any control axis, detection of excessively fast downward motion, loss of power onboard the UAV to any or all propulsion systems, and/or loss of control of the UAV due to signal interference or malicious intervention (e.g., hacking of the UAV control signals).

The parachute cover 220 may include multiple sections connected via hinges 245 to a central cover portion 240. Springs 250 in the hinges 245 cause the sections of the parachute cover 220 to actively and rapidly spread away from one another after the parachute cover 220 is released. While shown with three sections in FIG. 3A, the parachute cover 220 may spread into different numbers of sections (such as two or four) using similar mechanisms. Furthermore, while the parachute cover 220 is shown as a hinged dome in FIGS. 1A, 2A, 2B, and 3A, the parachute cover 220 may be shaped in other ways. For example, parachute cover 220 may be shaped as a cone, a pyramid, or other shapes.

The parachute cover 220 may be released when release pins 265 are retracted by the triggering mechanism 235. The release pins extend through securement holes in the base 210 and into securement tabs 260 in each section of the parachute cover 220. In some embodiments, when the parachute cover 220 is secured to the base 210, the parachute cover 220 also compresses the acceleration mechanism and holds the deployment tray in a position near the base 210. Alternatively, in other embodiments, the acceleration mechanism may be compressed and the deployment tray may be secured in a position near the base 210 by a separate latching mechanism (not shown). In these embodiments, the deployment tray and parachute cover 220 may be released by the triggering mechanism 235 at approximately the same time. For example, the triggering mechanism 235 may retract the release pins 265 securing the parachute cover 220 at approximately the same time that the latch securing the deployment tray is released.

FIG. 3B illustrates another perspective view of an embodiment of the parachute deployment system 205 in a stowed state, in accordance with various aspects of the present disclosure. As described in reference to FIGS. 2A, 2B, and 3A, the parachute deployment system 205 includes a base 210, a deployment tray (as shown in FIGS. 2A and 2B) and a parachute cover 220. A parachute (not shown) is stowed in the volume between the deployment tray and the parachute cover 220.

The parachute cover 220 is released when release pins 265 are retracted by the triggering mechanism 235. The release pins 265 extend through securement holes 255 in the base 210 and into securement tabs 260 in each section of the parachute cover 220. The triggering mechanism 235 may retract the release pins 265 by rotating a release lever 270 with a servo-actuator. The release pins 265 may be connected to the release lever 270 by linkages 275. When the triggering mechanism 235 actuates the release lever 270, the linkages 275 are pulled simultaneously, which causes each of the release pins 265 to retract from the securement tabs 260 at approximately the same time. The sections of the parachute cover 220 may then spread apart and the acceleration mechanism may propel the deployment tray (and thus the parachute) away from the base 210. The combination of the deployment tray propelling the parachute away from the base 210 and the parachute cover 220 pulling on the parachute (similarly to a pilot chute) causes the parachute to rapidly inflate away from the UAV.

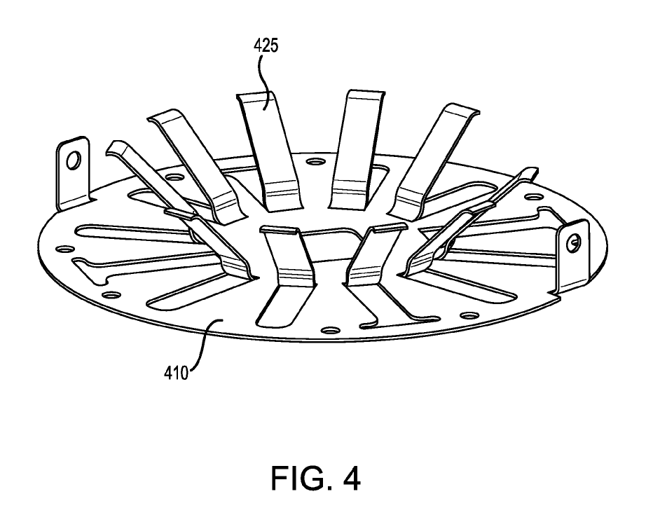

FIG. 4 illustrates an alternative embodiment of a base 410 and acceleration mechanism 425, in accordance with various aspects of the present disclosure. The base 410 may replace the base 210 described in reference to FIGS. 2A, 2B, 3A, and 3B. Similarly, the acceleration mechanism 425 may replace the acceleration mechanism 225. The acceleration mechanism 425 uses multiple leaf springs to propel a deployment tray away from the base 410. The base 410 and acceleration mechanism 425 may be combined with the other components of the parachute deployment system described in reference to FIGS. 2A, 2B, 3A, and 3B, and may allow the parachute deployment system to operate in a similar way.

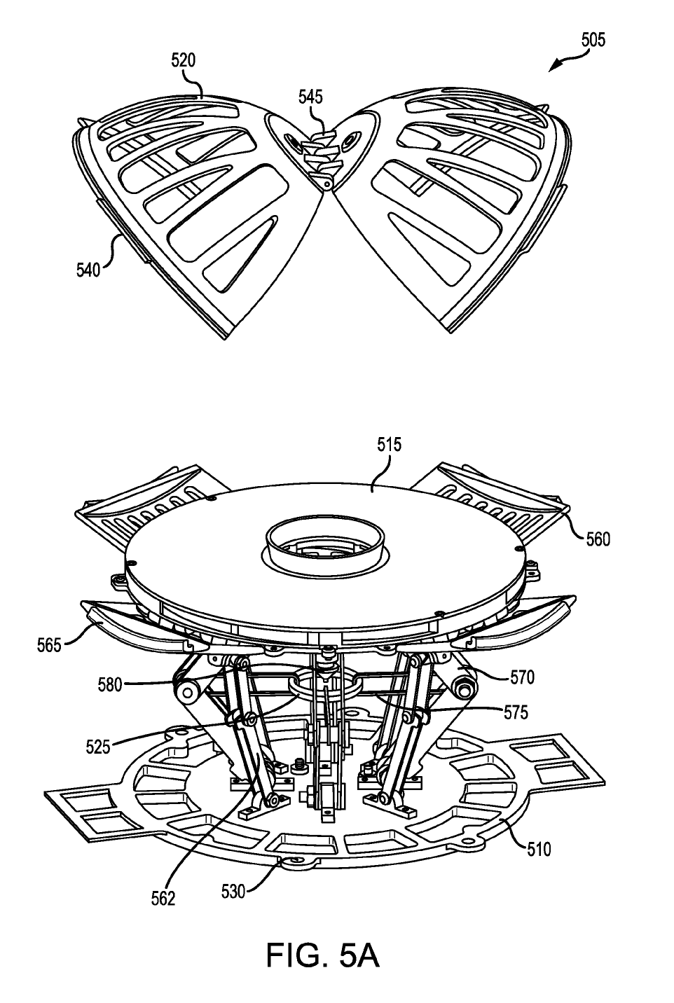

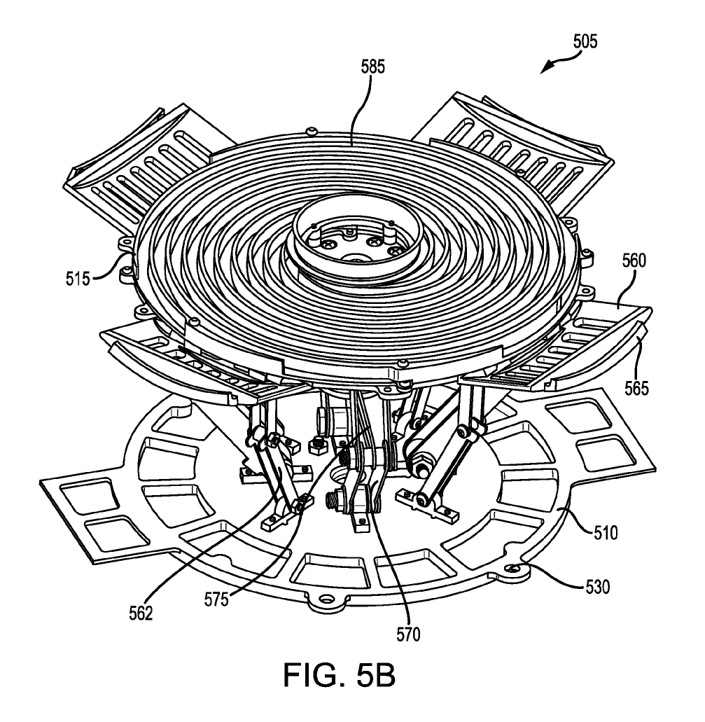

FIG. 5A illustrates a perspective view of an embodiment of a parachute deployment system 505 in a partially deployed state, in accordance with various aspects of the present disclosure. The parachute deployment system 505 includes a base 510, a deployment tray 515, and a parachute cover 520. A parachute (not shown) is positioned between the parachute cover 520 and the deployment tray 515. The parachute may include multiple suspension lines that attach to the base 510 or that attach directly to a UAV. When the parachute is deployed, the suspension lines support the UAV and allow the UAV to descend at a reduced speed.

The base 510 may attach to the UAV via attachment points 530. For example, screws may attach the base 510 to the body of the UAV via the attached points 530. Alternatively, in some embodiments, the base 510 may not include attachment points 530, and instead may be integral to the UAV, such as shown in FIG. 1B. In these embodiments, the parachute cover 520 may form a portion of the body of the UAV.

An acceleration mechanism mechanically connects the deployment tray 515 to the base 510. The acceleration mechanism includes a rigid spring support ring 525, primary lift linkages 570, and elastomeric or other type of springs 575. The springs 575 mechanically connect the support ring 525 to a central hinge in each of the primary lift linkages 570. As the linkages 570 are compressed (moving the deployment tray 515 closer to the base 510), the central hinges of each linkage 570 move outward. This outward movement causes each of the springs 575 to pull and stretch away from the support ring 525, which stores potential energy in the springs 575. When the deployment tray 515 is released, an opposite movement occurs. The energy in the springs 575 pull each of the hinges of the primary lift linkages 570 inward. This inward movement causes each of the primary lift linkages 570 to rapidly lift the deployment tray 515 away from the base 510, which propels the parachute and parachute cover 520 away from the UAV. The primary lift linkages 570 lift the deployment tray 515 away from the UAV to a distance where the parachute and suspension lines are clear of the rotors of the UAV.

When the parachute is stowed, the parachute cover 520 may be secured to the parachute deployment system 505 by multiple doors 560. Each of the doors 560 include a lip 565 which engage tabs 540 around the periphery of the parachute cover 520. The doors 560 are mechanically connected to the base 510 via door linkages 562. As the deployment tray 515 moves away from the base 510, the door linkages 562 cause the doors 560 to pivot outward from the deployment tray 515, as shown in FIG. 5A. Thus, the upward movement of the deployment tray 515 (caused by the mechanical energy stored in the springs 575) pivots the doors 560 to release the parachute cover 520 while at approximately the same time that the deployment tray 515 propels the parachute away from the UAV. Depending on the size and geometry of the parachute and parachute cover 520, the number of doors 560 may vary.

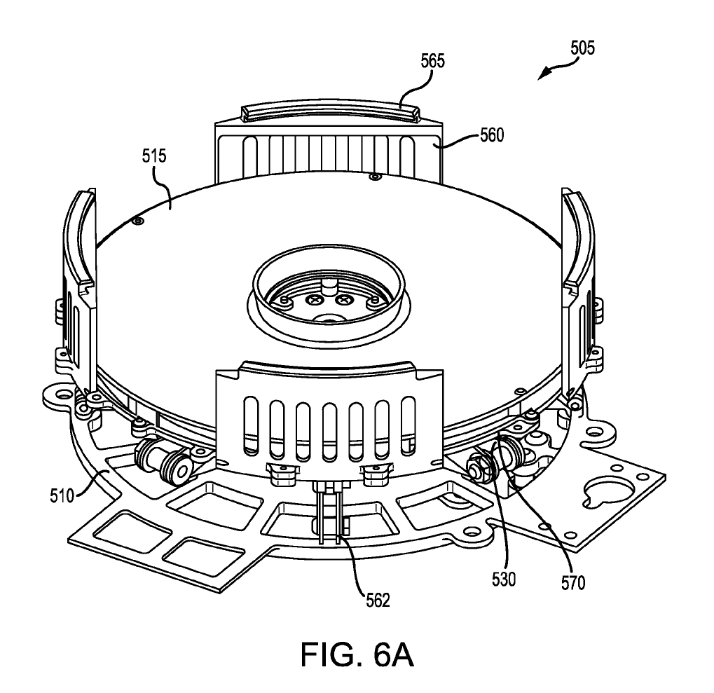

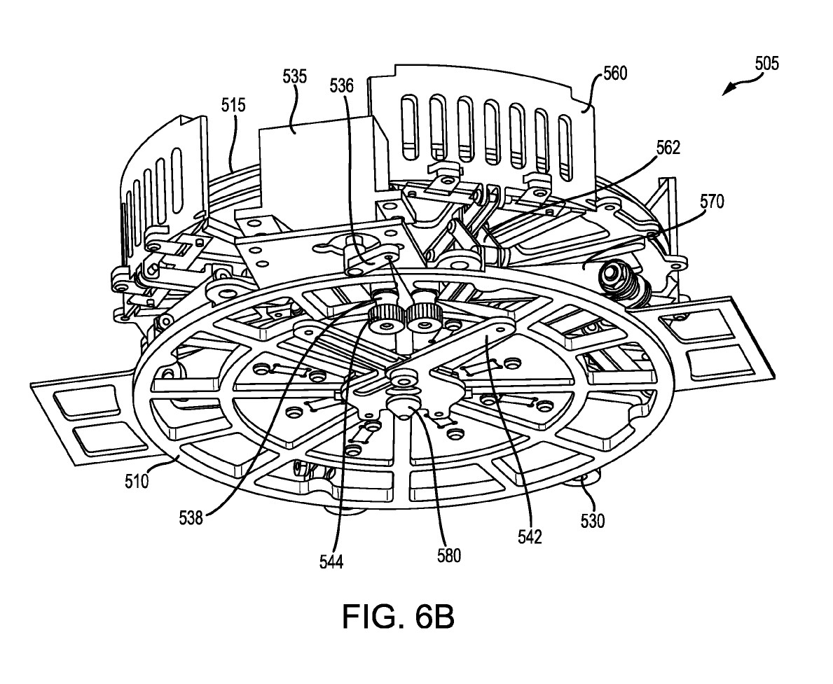

A triggering mechanism (shown in FIG. 6B) causes the acceleration mechanism and doors 560 to release the parachute cover 520 and propel the deployment tray 515 away from the base 510, as shown in FIG. 5A. The triggering mechanism activates the acceleration mechanism and doors 560 by releasing a release pin 580. When the parachute is in a stowed state, the release pin 580 penetrates the base 510 and is secured below the base 510 with a latching mechanism (as shown in FIG. 6B). The triggering mechanism releases the latching mechanism to activate the acceleration mechanism and doors 560. The triggering mechanism may include a power source (e.g., a battery) and control electronics. The triggering mechanism may be triggered manually, by the pilot of the UAV via remote-control, or automatically by an automatic triggering system. The automatic triggering system may be a component of the UAV or may be a component of the parachute deployment system (e.g., a component of the triggering mechanism). The automatic triggering system may use sensor data either from the UAV's onboard flight control system or from sensors built into the control electronics of the triggering mechanism. The triggering mechanism may be automatically activated when any of a set of rules is broken. For example, the rules may include excessive rotation rate in any control axis, excessive tilt angle from horizontal in any control axis, detection of excessively fast downward motion, loss of power onboard the UAV to any or all propulsion systems, and/or loss of control of the UAV due to signal interference or malicious intervention (e.g., hacking of the UAV control signals).

In some embodiments, the parachute deployment system 505 and/or UAV may include a recording device to record and report data, such as flight path, location, and crash conditions. The recording device may include sensors to record the status of various components of the UAV, such as rotor speed and battery level. The recording device may transmit the recorded data to a receiving device upon a crash condition or upon a user command. Alternatively, the recorded data may be retrieved from the recording device manually by a user, such as with a USB interface.

When the parachute cover 520 is released by the doors 560 and propelled away from the UAV by the triggering mechanism, the parachute cover 520 may spread into multiple sections. The sections of the parachute cover 520 are connected via a hinge 545. A torsion spring may be included in the hinge 545 to cause the sections of the parachute cover 520 to spread after the parachute cover 520 is released. While shown with two sections in FIG. 5A, the parachute cover 520 may spread into different numbers of sections (such as three or four) using similar mechanisms. The parachute cover 520 shown in FIG. 5A includes multiple cutouts in each section to reduce weight. However, in some embodiments, the sections of the parachute cover 520 may be solid to produce more drag. Furthermore, while the parachute cover 520 is shown as a hinged dome in FIG. 5A, the parachute cover 520 may be shaped in other ways. For example, parachute cover 520 may be shaped as a cone, a pyramid, or other shapes.

In some embodiments, a pilot line (not shown) may connect the parachute cover 520 to the parachute. Thus, when the parachute cover 520 is released and spreads apart, the parachute cover 520 may act as a pilot chute for the parachute, pulling the parachute, via the pilot line, away from the parachute deployment system 505 and the UAV. By pulling on the parachute with the parachute cover 520, the parachute may rapidly inflate away from the UAV. In addition, the pilot line may keep the parachute cover 520 connected to the parachute deployment system 505 and UAV, allowing the parachute cover 520 to be reused. In these embodiments, the sections of the parachute cover 520 may not include the cutouts shown in FIG. 5A, and instead may be solid to increase drag for pulling on the parachute. Furthermore, in some embodiments, the parachute cover 520 may include a flexible or elastic material (not shown) between the sections of the parachute cover 520. The flexible material may provide the parachute cover 520 with more drag and may allow the parachute cover 520 to more efficiently pull on the parachute when it is released.

FIG. 5B illustrates a perspective view of an embodiment of the parachute deployment system 505, in accordance with various aspects of the present disclosure. The parachute deployment system 505 shown in FIG. 5B includes the same components as the deployment system 505 described in reference to FIG. 5A. The top of the deployment tray 515 is removed in FIG. 5B to illustrate spiral channels 585 within the deployment tray 515. The spiral channels 585 are used to store the suspension lines of the parachute when the parachute is stowed between the parachute cover and the deployment tray 515. The spiral channels 585 keep the suspension lines from entangling with each other or with components of the parachute deployment system 505 when the deployment tray 515 propels the parachute away from the UAV. The suspension lines of the parachute are inserted into the spiral channels 585 through openings along the edge of the deployment tray 515 when the parachute is stowed within the parachute deployment system 505. A flexible insertion device may be used to aid with inserting the suspension lines.

FIG. 6A illustrates a perspective view of an embodiment of the parachute deployment system 505 in a stowed state, in accordance with various aspects of the present disclosure. As described in reference to FIGS. 5A and 5B, the parachute deployment system 505 includes a base 510, a deployment tray 515, a parachute cover (as shown in FIG. 5A), and an acceleration mechanism. A parachute (not shown) is stowed in the volume between the deployment tray 515 and the parachute cover.

The base 510 may attach to the UAV via attachment points 530. For example, screws may attach the base 510 to the body of the UAV via the attached points 530. Alternatively, in some embodiments, the base 510 may not include attachment points 530, and instead may be integral to the UAV, such as shown in FIG. 1B. In these embodiments, the parachute cover 520 may form a portion of the body of the UAV.

The acceleration mechanism mechanically connects the deployment tray 515 to the base 510 via primary lift linkages 570. When the parachute is stowed, the linkages 570 are compressed and the central hinges of each primary lift linkage 570 are near the periphery of the parachute deployment system 505. When the deployment tray 515 is released, the hinges of the primary lift linkages 570 move inward. This inward movement causes each of the linkages 570 to rapidly lift the deployment tray 515 away from the base 510, which propels the parachute and parachute cover away from the UAV. The primary lift linkages 570 lift the deployment tray 515 away from the UAV to a distance where the parachute and suspension lines are clear of the rotors of the UAV.

When the parachute is stowed, the parachute cover may be secured to the parachute deployment system 505 by multiple doors 560. Each of the doors 560 include a lip 565 which engage tabs around the periphery of the parachute cover 520. The doors 560 are mechanically connected to the base 510 via door linkages 562. When the parachute is stowed, the door linkages 562 hold the doors in a vertical orientation, which secures the parachute cover. As the deployment tray 515 moves away from the base 510, the door linkages 562 cause the doors 560 to pivot outward from the deployment tray 515, as shown in FIG. 5A. Thus, the upward movement of the deployment tray 515 pivots the doors 560 to release the parachute cover while at approximately the same time that the deployment tray 515 propels the parachute away from the UAV. Depending on the size and geometry of the parachute and parachute cover, the number of doors 560 may vary.

FIG. 6B illustrates another perspective view of an embodiment of the parachute deployment system 505 in a stowed state, in accordance with various aspects of the present disclosure. As described in reference to FIGS. 5A, 5B, and 6A, the parachute deployment system 505 includes a base 510, a deployment tray 515, a parachute cover (shown in FIG. 5A), and an acceleration mechanism. A parachute (not shown) is stowed in the volume between the deployment tray and the parachute cover.

A triggering mechanism 535 causes the acceleration mechanism (i.e., the spring support ring 525, primary lift linkages 570, and springs 575) and doors 560 to release the parachute cover and propel the deployment tray 515 away from the base 510, as shown in FIG. 5A. The triggering mechanism 535 activates the acceleration mechanism and doors 560 by releasing a release pin 580. When the parachute is in a stowed state, the release pin 580 penetrates the base 510 and is secured below the base 510 with a latching mechanism 542. The triggering mechanism 535 activates the latching mechanism 542 by actuating a release lever 536 with a servo-actuator. The latching mechanism 542 may be connected to the release lever 536 by release lanyards or linkages 538. The release lanyards or linkages 538 may be routed around spools 544, which allow the release lanyards or linkages 538 to be pulled simultaneously by the release lever 536. This causes the latching mechanism 542 to release the release pin 580. The acceleration mechanism is then activated, which raises the deployment tray 515 and pivots the doors 560 outward from the deployment tray 515. The upward movement of the deployment tray 515 and the release of the parachute cover then propels the parachute away from the UAV.

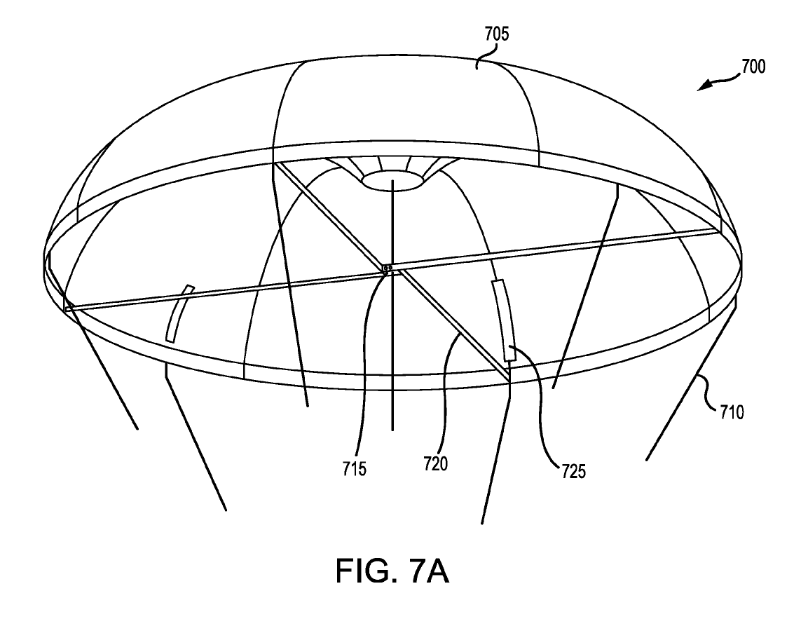

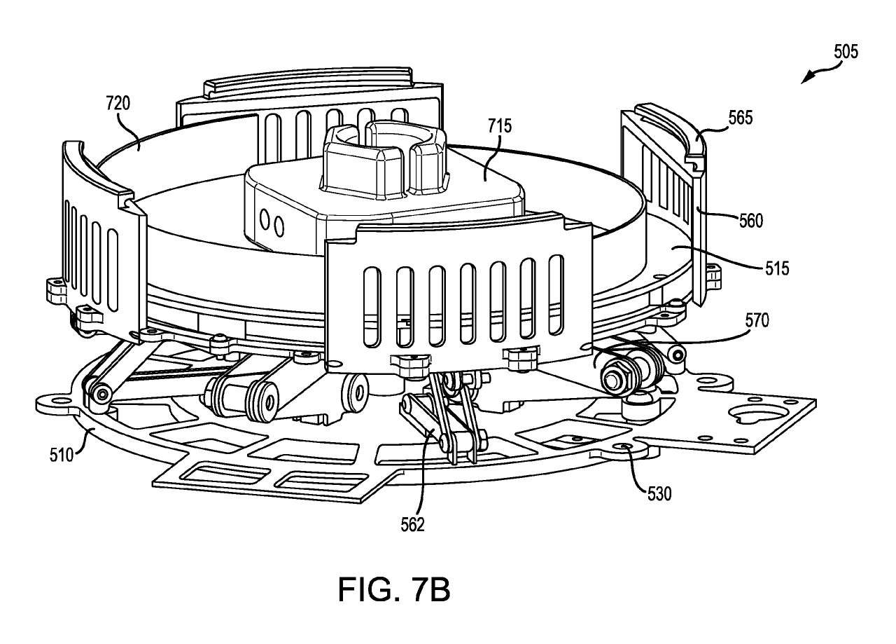

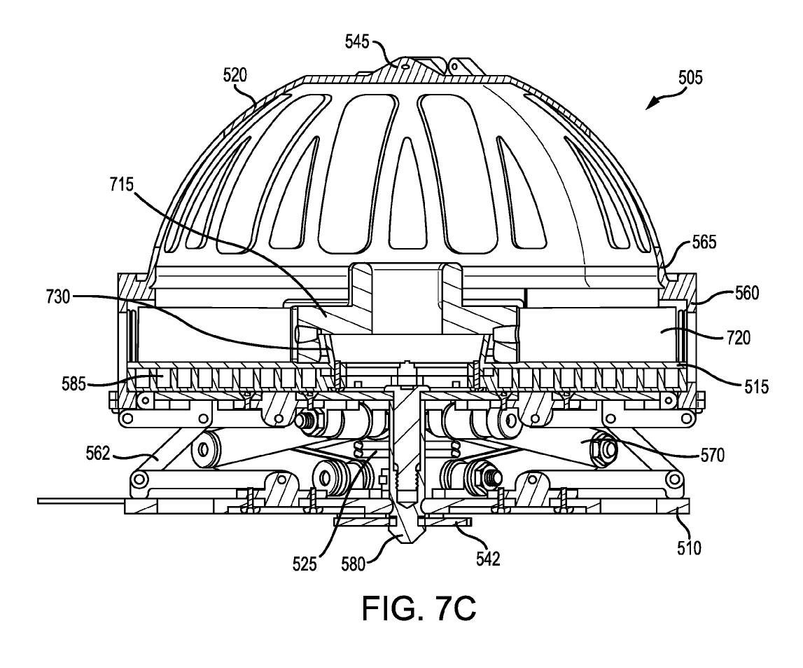

FIG. 7A illustrates a perspective view of an embodiment of a parachute 700, in accordance with various aspects of the present disclosure. The parachute 700 includes a canopy 705 and multiple suspension lines 710. The parachute 700 may be folded into a compact configuration and enclosed in the volume between the parachute cover and the deployment tray of the parachute deployment systems described in reference to FIGS. 1A-6B. The suspension lines 710 may attach to the base or deployment tray of the parachute deployment systems, or the suspension lines 710 may attach directly to the UAV. When the parachute 700 is deployed, the suspension lines support the UAV and allow the UAV to descend at a reduced speed.

In some embodiments, the parachute 700 includes a central hub 715. One or more torsion springs 720 may extend between the central hub 715 and the lower skirt of the parachute 700. The torsion springs 720 may be compressed when the parachute is stowed in the parachute deployment system. When the parachute 700 is propelled away from the parachute deployment system, the torsion springs 720 may rapidly expand, which allows the parachute 700 to quickly inflate. By rapidly deploying and inflating the parachute 700, the parachute deployment system allows a UAV to gradually descend in an emergency when the UAV is at a relatively low altitude.

In some embodiments, the parachute 700 may also include pockets 725 for storing the suspension lines 710. The suspension lines may be inserted into the pockets 725 when the parachute 700 is stowed in the parachute deployment system. The pockets 725 may prevent the suspension lines 710 from entangling with each other, or with components of the parachute deployment system, when the parachute is propelled away from the UAV.

FIG. 7B illustrates a perspective view of an embodiment of the parachute deployment system 505, in accordance with various aspects of the present disclosure. The parachute deployment system 505 shown in FIG. 7B includes the same components as the parachute deployment system 505 described in reference to FIG. 5A, 5B, 6A, and 6B. FIG. 7B further illustrates the central hub 715 and a torsion spring 720 of the parachute 700 (as described in reference to FIG. 7A) when the parachute 700 is stowed within the parachute deployment system 505. For clarity, other components of the parachute 700 (i.e., the canopy 705 and suspension lines 710) and the parachute cover are not shown. The central hub 715 and torsion spring 720 are positioned on top of the deployment tray 515. The torsion spring 720 is compressed by rotating the central hub 715. As the central hub 715 is rotated, the torsion spring 720 forms a spiral on top of the deployment tray 515. The doors 560 hold the torsion spring 720 in the spiral configuration until the parachute deployment system 505 is activated. When the parachute deployment system 505 is activated, the doors 560 pivot outward from the deployment tray 515, and the deployment tray 515 is propelled away from the base 510. These movements propel the parachute 700 away from the parachute deployment system 505 and allow the torsion spring 720 to expand, as shown in FIG. 7A. In this way, the parachute 700 rapidly inflates away from the UAV. This may prevent the parachute 700 and/or suspension lines 710 from being entangled with components of the UAV (such as rotors).

FIG. 7C illustrates a sectional view of an embodiment of the parachute deployment system 505, in accordance with various aspects of the present disclosure. The parachute deployment system 505 shown in FIG. 7C includes the same components as the parachute deployment system 505 described in reference to FIG. 5A, 5B, 6A, 6B, and 7B. FIG. 7C further illustrates the central hub 715 and a torsion spring 720 of the parachute 700 (as described in reference to FIG. 7A) when the parachute 700 is stowed within the parachute deployment system 505. For clarity, other components of the parachute 700 (i.e., the canopy 705 and suspension lines 710) are not shown. It should be understood that the canopy 705 may be folded and compressed in such a way as to occupy the volume between the parachute cover 520 and the deployment tray 515.

The suspension lines 710 of the parachute 700 may be inserted into the spiral channels 585 of the deployment tray 515. The spiral channels 585 keep the suspension lines 710 from entangling with each other or with components of the parachute deployment system 505 when the deployment tray 515 propels the parachute 700 away from the UAV. The suspension lines 710 may be inserted into the spiral channels 585 through openings along the edge of the deployment tray 515 when the parachute is stowed. A flexible insertion device may be used to aid with inserting the suspension lines.

The central hub 715 and torsion spring 720 are positioned on top of the deployment tray 515. The torsion spring 720 is compressed by rotating the central hub 715. A guide ring 730 on top of the deployment tray 515 may aid in rotating the central hub 715. The guide ring 730 may also keep the parachute centered on the deployment tray 515 while the central hub 715 is rotated. As the central hub 715 is rotated, the torsion spring 720 forms a spiral on top of the deployment tray 515. The doors 560 hold the torsion spring 720 in the spiral configuration until the parachute deployment system 505 is activated. When the parachute deployment system 505 is activated, the doors 560 pivot outward from the deployment tray 515, and the deployment tray 515 is propelled away from the base 510. These movements propel the parachute cover 520 and parachute 700 away from the parachute deployment system 505, and also allow the parachute cover 520 to spread into multiple sections. By spreading into the multiple sections, the parachute cover 520 more easily separates from the parachute 700. When the parachute 700 is released from the parachute deployment system 505, the torsion springs 720 expand, as shown in FIG. 7A. In this way, the parachute 700 rapidly inflates away from the UAV.

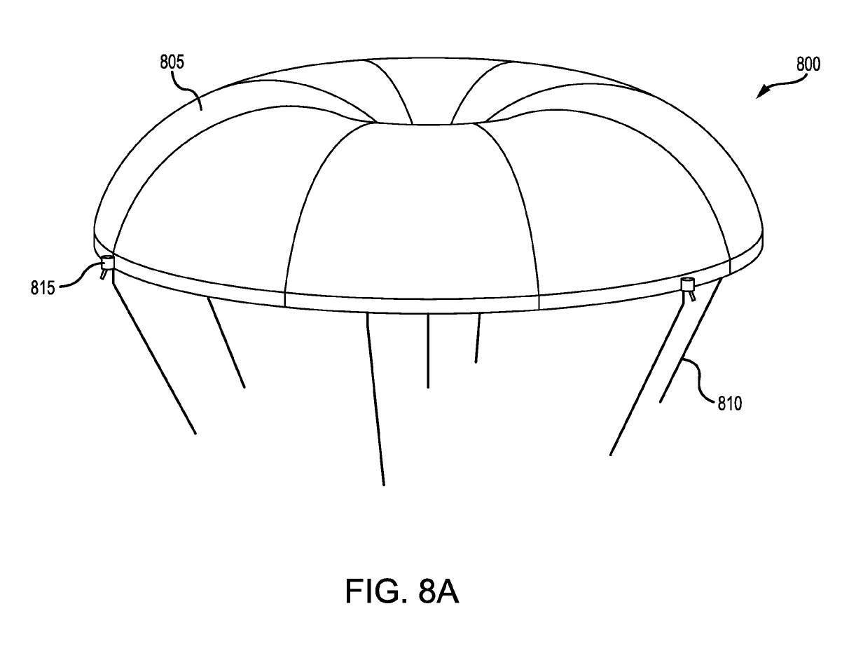

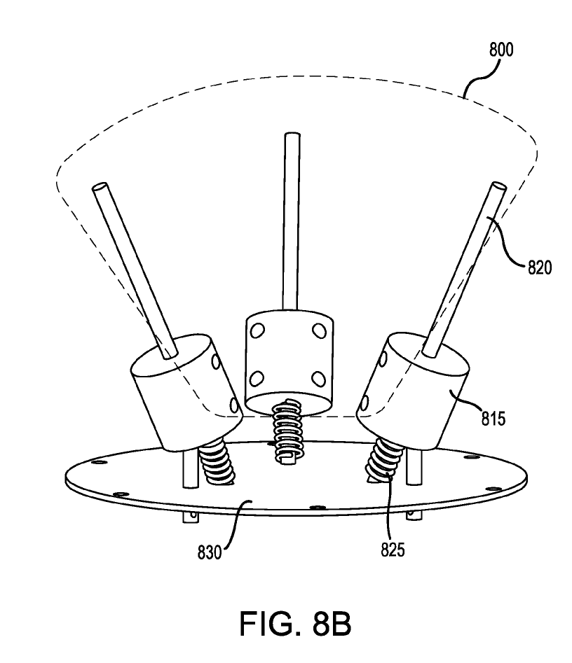

FIG. 8A illustrates a perspective view of an embodiment of a parachute 800, in accordance with various aspects of the present disclosure. The parachute 800 includes a canopy 805 and multiple suspension lines 810. The parachute 800 may be folded into a compact configuration and enclosed in the volume between the parachute cover and the deployment tray of the parachute deployment systems described in reference to FIGS. 1A-6B. The suspension lines 810 may attach to the base or deployment tray of the parachute deployment systems, or the suspension lines 810 may attach directly to the UAV. When the parachute 800 is deployed, the suspension lines support the UAV and allow the UAV to descend at a reduced speed.

In some embodiments, the parachute 800 includes multiple weights 815 positioned around the lower skirt of the parachute 800. The weights 815 may be propelled upward and outward away from the UAV by an acceleration mechanism (as shown in FIG. 8B) of a parachute deployment system. When the weights 815 are propelled away from the UAV, the weights 815 may pull the canopy 805 open, which allows the parachute 800 to quickly inflate. By rapidly deploying and inflating the parachute 800, the parachute deployment system allows a UAV to gradually descend in an emergency when the UAV is at a relatively low altitude.

FIG. 8B illustrates an embodiment of a deployment tray top 830 and launching mechanism 825 for a parachute deployment system, in accordance with various aspects of the present disclosure. The deployment tray top 830 and launching mechanism 825 may be components of one or more of the deployment trays described in reference to FIGS. 2A-6B. The launching mechanism 825 propels weights 815 upward and outward away from the UAV. The launching mechanism 825 may include coil springs as shown, or other types of mechanisms for storing mechanical energy. The weights are attached to the lower skirt of the parachute 800, as shown in FIG. 8A. Multiple angled guide rods 820 guide the weights 815 into upward and outward directions when the launching mechanism is activated. The springs of the launching mechanism 825 are held in a compressed state when the parachute is stowed in the parachute deployment system. The launching mechanism 825 may be activated when the deployment tray is triggered to propel the parachute 800 away from the UAV. When the weights 815 are propelled upward and outward from the UAV, the weights 815 may pull the canopy 805 of the parachute 800 open, which allows the parachute 800 to quickly inflate. By rapidly deploying and inflating the parachute 800, the parachute deployment system allows a UAV to gradually descend in an emergency when the UAV is at a relatively low altitude.

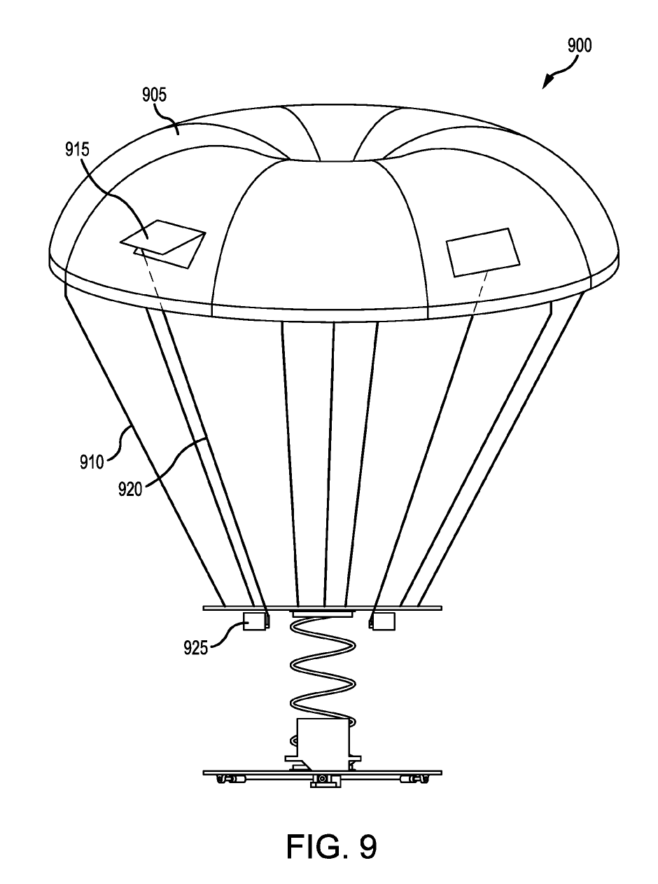

FIG. 9 illustrates an embodiment of a steerable parachute 900, in accordance with various aspects of the present disclosure. The steerable parachute 900 may be a component of any of the parachute deployment systems described in reference to FIGS. 1A-8B. The steerable parachute 900 includes a canopy 905 and suspension lines 910. The deployment of the canopy 905 may be accelerated by a pilot chute (i.e., a parachute cover), weights, and/or torsion springs, as described in reference to FIGS. 2A-8B. While shown attached to the deployment tray of a parachute deployment system, the suspension lines 910 of the steerable parachute 900 may attach to the base, or to other components of the parachute deployment system or UAV.

Once deployed, the steerable parachute 900 may control or steer the UAV during descent using one or more air vents 915. The air vents 915 may be connected to one or more steering servos 925 by steering lines 920. The steering servos 925 open or close the air vents 915 by releasing or pulling the steering lines 920. The steering servos 925 may be controlled by commands given by a pilot operating the UAV after the steerable parachute 900 deploys. The pilot may control the descent of the UAV by opening the air vent 915 on one side of the canopy 905, which causes the UAV to descend in the opposite direction of the open air vent 915. Multiple air vents 915 may be opened at the same time to offer more precise control of the descent direction. The pilot may also control how fast the direction is changed by controlling the degree to which each air vent 915 is opened (e.g. 30% opened, 100% opened, etc.). In this way, the pilot may control the descent of the UAV to avoid obstacles in the air or on the ground and land at a preferred location.

The components described above are meant to exemplify some types of possibilities. In no way should the aforementioned examples limit the scope of the technology, as they are only embodiments.

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology, as those skilled in the relevant art will recognize. The various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. Where the context permits, singular or plural terms may also include the plural or singular term, respectively.

Further, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

1. A parachute deployment system for an unmanned aerial vehicle, comprising:
a base attached to the unmanned aerial vehicle;
a deployment tray mechanically connected to the base;
an acceleration mechanism for propelling the deployment tray away from the base;
a parachute cover releasably secured over the deployment tray;
a parachute stowed between the deployment tray and the parachute cover, the parachute having a plurality of suspension lines for supporting the unmanned aerial vehicle when the parachute is deployed; and
a triggering mechanism, wherein upon activation of the triggering mechanism, the parachute cover is released and the deployment tray is propelled away from the base, deploying the parachute.

2. (canceled)

3. The system of claim 1, wherein the parachute cover is releasably secured over the deployment tray by a plurality of doors.

4. The system of claim 3, wherein the parachute includes one or more torsion springs for rapidly inflating the parachute, and the plurality of doors at least partially hold the one or more torsion springs in a compressed state while the parachute is stowed.

5. (canceled)

6. The system of claim 1, wherein the parachute cover comprises a plurality of hinged sections, each hinged section spreading away from each other hinged section upon release of the parachute cover.

7. (canceled)

8. The system of claim 1, wherein the released parachute cover pulls the parachute away from the unmanned aerial vehicle and allows the parachute to inflate.

9. The system of claim 1, wherein the acceleration mechanism raises the deployment tray away from the base to a distance that allows the parachute and parachute suspension lines to clear one or more rotors of the unmanned aerial vehicle.

10. The system of claim 1, wherein the parachute suspension lines are at least partially stored within the deployment tray.

11. The system of claim 1, wherein the parachute suspension lines are at least partially stored within pockets of the parachute.

12. (canceled)

13. (canceled)

14. (canceled)

15. (canceled)

16. The system of claim 1, wherein the triggering mechanism is activated based on an automatic triggering system, a user command, or a combination thereof.

17. The system of claim 1, wherein the parachute includes one or more air vents controlled by the parachute deployment system when the parachute is released.

18. An unmanned aerial vehicle, comprising:
a body;
at least one rotor; and
a parachute deployment system, the parachute deployment system comprising:
a base attached to the body;
a deployment tray mechanically connected to the base;
an acceleration mechanism for propelling the deployment tray away from the base;
a parachute cover releasably secured over the deployment tray;
a parachute stowed between the deployment tray and the parachute cover, the parachute having a plurality of suspension lines for supporting the unmanned aerial vehicle when the parachute is deployed; and
a triggering mechanism, wherein upon activation of the triggering mechanism, the parachute cover is released and the deployment tray is propelled away from the base, deploying the parachute.

19. (canceled)

20. The unmanned aerial vehicle of claim 18, wherein the parachute cover is releasably secured over the deployment tray by a plurality of doors.

21. The unmanned aerial vehicle of claim 20, wherein the parachute includes one or more torsion springs for rapidly inflating the parachute, and the plurality of doors at least partially hold the one or more torsion springs in a compressed state while the parachute is stowed.

22. The unmanned aerial vehicle of claim 20, wherein the triggering mechanism causes the plurality of doors to release the parachute cover at approximately the same time that the deployment tray is propelled away from the base.

23. The unmanned aerial vehicle of claim 18, wherein the parachute cover comprises a plurality of hinged sections, each hinged section spreading away from each other hinged section upon release of the parachute cover.

24. The unmanned aerial vehicle of claim 18, wherein each hinged section includes a spring mechanism for accelerating the spreading away from each other hinged section.

25. The unmanned aerial vehicle of claim 18, wherein the released parachute cover pulls the parachute away from the unmanned aerial vehicle and allows the parachute to inflate.

26. (canceled)

27. The unmanned aerial vehicle of claim 18, wherein the triggering mechanism is activated based on an automatic triggering system, a user command, or a combination thereof.

28. The unmanned aerial vehicle of claim 18, wherein the parachute includes one or more air vents controlled by the parachute deployment system when the parachute is released.

29. A method for deploying a parachute on an unmanned aerial vehicle, comprising:
activating a triggering mechanism;
propelling a deployment tray away from the unmanned aerial vehicle;
releasing a parachute cover approximately simultaneously to the propelling of the deployment tray; and
deploying a parachute stowed between the deployment tray and parachute cover, wherein the parachute is propelled away from the unmanned aerial vehicle by the deployment tray.
